(19) United States
(12) Patent Application Publication
(10) Pub. No.: US 2012/0200067 A1
(43) Pub. Date: Aug. 9, 2012

(54) Trailer hitch lock

(76) Inventor: Brent Bonham, Sandy, UT (US)

(21) Appl. No.: 12/931,548

(22) Filed: Feb. 4, 2011

(51) Int. Cl. B60D 1/58

(52) U.S. Cl. 280/507

(57) ABSTRACT

A lock for trailer hitches that is inexpensive and easy to use and that will secure the coupler fixed to the end of a trailer hitch to prevent unauthorized hook-up and towing of the trailer and items carried on or in the trailer. The lock is formed with a bottom plate having a flat top surface, a top plate having a flat bottom surface to overlie a portion of the bottom plate and a pivot pin fixed to the bottom plate and about which the top plate revolves. A bumper fixed to the top of the pivot pin holds the top plate over the bottom plate and extends upwardly to engage the interior of the coupler and to keep the lock from sliding off the coupler when side flanges on the plates are positioned over a surrounding flange on the coupler and a padlock hasp is positioned through aligned holes in the plates.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

### Field of the Invention

This invention relates to trailer hitch locks applied to trailer hitch couplings to prevent theft of trailers and items carried on, or in the trailer.

### BRIEF SUMMARY OF THE INVENTION

### Objects of the Invention

It is very common for thieves to connect a tow hitch on a tow vehicle to the trailer coupling on the tongue of a parked trailer and to drive away with the trailer and any load carried by the trailer at the time of the theft. A great many locks and lock systems have been developed, proposed and used in attempts to keep thieves from achieving their theft goal. Some of the known systems are very expensive and use special metals and other expensive components in attempts to keep the thieves from disabling the lock system and stealing the trailer and its load. Unfortunately for the owners of trailers, it is widely believed that if a thief wants a trailer and is given the time and proper tools he will be able to disable the lock or lock system and drive away with the trailer.

It is also believed that often the theft of the trailer, with or without a load thereon, is often a crime of convenience. Thus, a thief may decide to make a theft on the spur of the moment and at a time when he does not have special cutting, or other special tools.

It is a principal object of the present invention to provide a low cost lock for a trailer hitch that will deter trailer thefts by making it difficult for a thief to steal a trailer without the use of special tools, such as powerful bolt cutters and saws capable of quickly and easily cutting a padlock hasp.

It is a principal object of the present invention to provide a low cost, easy to use, effective lock to be secured to the trailer hitch coupling located on the tongue of a trailer.

It is a further object of the present invention to provide a lock for a trailer hitch that is very easy to apply to the hitch.

### FEATURES OF THE INVENTION

Principal features of the lock system of the invention include a bottom plate with an in-turned flange on one side thereof; a top plate with an in-turned flange on one side thereof and a cut away corner; a pivot pin extending centrally through both plates and upwardly from the top surface of the top plate; a bumper fixed to the top of the pivot pin and extending upwardly therefrom and from the top plate to hold the top plate in position overlying a portion of the bottom plate; and aligned hasp receiving holes through the plates to receive a padlock hasp when the lock system is locked to the coupling member on the end of a trailer tongue.

Additional objects and features of the invention will become apparent from the following drawings and detailed description.

### BRIEF DESCRIPTION OF THE DRAWINGS OF THE INVENTION

In the Drawings

FIG. 1 is a perspective view of the trailer hitch lock of the invention showing the rotation of the top plate with respect to the bottom plate and the plates in position to be fitted onto a hitch coupling member at the end of a trailer tongue (not shown);

FIG. 2, a perspective view showing the top and bottom plates aligned to be in the locking position of the lock;

FIG. 3, a top plan view showing the top and bottom plates in the position of FIG. 1, and with a hitch coupling member at the end of a trailer tongue (not shown) in dotted line;

FIG. 4, a view like that of FIG. 3, showing the top and bottom plates in the position of FIG. 2 and a hitch coupling member in dotted line;

FIG. 5, a section taken on the line 5-5 of FIG. 2; and

FIG. 6, a perspective view of the hitch lock of the invention, locked on a hitch coupling member (shown fragmentarily) at the end of a trailer tongue (not shown).

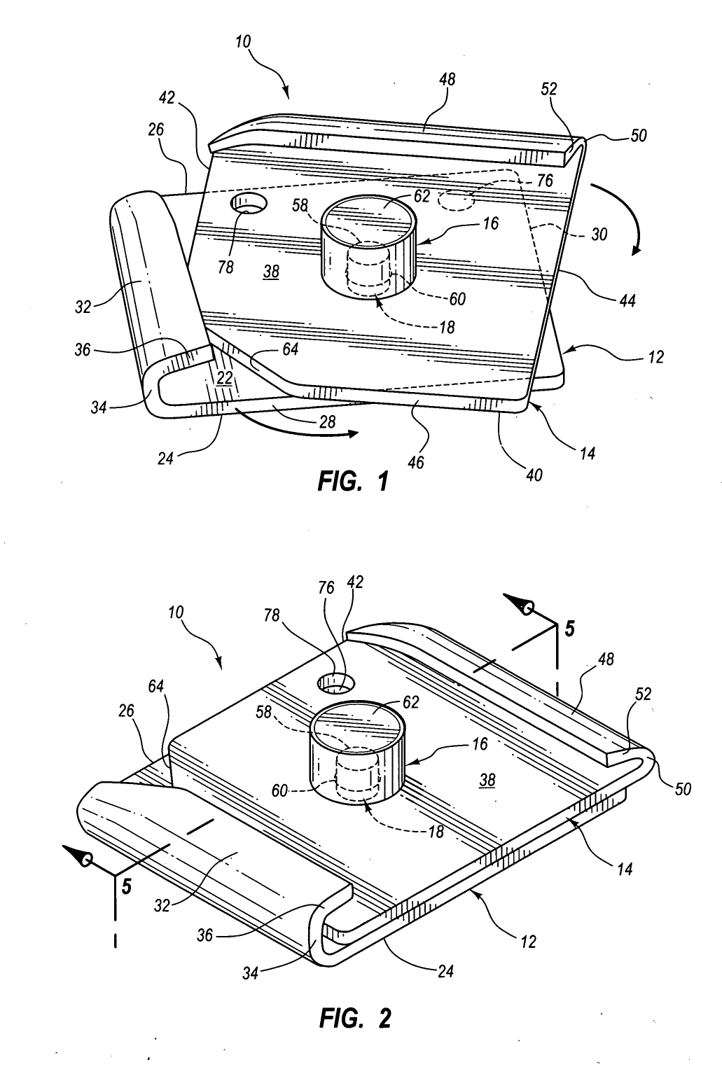

### DETAILED DESCRIPTION

Referring Now to the Drawings

In the preferred embodiment of the invention, the trailer hitch lock of the invention, shown generally at 10, includes a bottom plate 12, a top plate 14, a bumper 16, a pivot shaft 18, and a padlock, shown generally at 20.

Bottom plate 12 has a flat op surface 22 and a flat bottom surface 24. Bottom plate 12 further includes a front edge 26, a rear edge 28, a side edge 30 at one side of the plate and a flange 32 extending along a side opposite the side edge 30. Flange 32 has a leg 34 that extends upwardly from the top surface 22 and an in-turned leg 36 that extends inwardly over a portion of the top plate 14.

Top plate 14 has a flat top surface 38 and a bottom flat surface 40. The top plate further includes a front edge 42, a rear edge 44, a side edge 46 at one side of the plate, and a flange 48 extending along a side opposite the side edge 46. Flange 48 has a leg 50 that extends upwardly from the top surface 38 and an in-turned leg 52 that extends inwardly over a portion of the top plate 14.

Bottom flat surface 40 of top plate 14 rests on and slides on the flat top surface 22 of bottom plate 12.

A pivot shaft 58 projects upwardly from the top surface 22 and through a hole 60 in the top plate 14, such that the top plate will rotate around the pivot shaft. An enlarged bumper 62 is provided on the top of pivot shaft 58 and projects upwardly above the flat top surface 38. Bumper 62 holds top plate 14 in sliding engagement with bottom plate 12 as the top plate rotates with respect to the bottom plate, around pivot shaft 58.

Top plate 14 has two operating positions with respect to the bottom plate 12, i.e., a locking position where the flange 48 of the top plate is spaced from and parallel to the flange 32 of bottom plate 12, and an insertion position where the top plate 14 is pivoted to position flange 48 to extend normal to, or nearly normal to, the flange 32 of bottom plate 12. The corner 64 of top plate 14 is formed as an arcuate curve to allow the corner to turn beneath the in-turned leg 36 of flange 32 of the bottom plate 12. The distance from the top surface of top plate 14 to the bottom surface of the in-turned leg 36 is the same as the distance from the top surface of the top plate 14 to the bottom surface of in-turned leg 52.

The trailer hitch lock 10 is particularly adapted for use with trailer hitch systems having an upwardly projecting ball attached to a towing vehicle (not shown) and a coupler 70 attached to the tongue of a trailer (not shown). The coupler 70 is shaped to fit over the ball and a locking mechanism (not shown) is used to lock the coupler 70 to the ball. Frequently, the open bottom of the coupler is formed with an outwardly extending, encircling flange 72, FIG. 5. Flange 72 helps to guide the coupler onto the ball when the trailer is being connected to the tow vehicle.

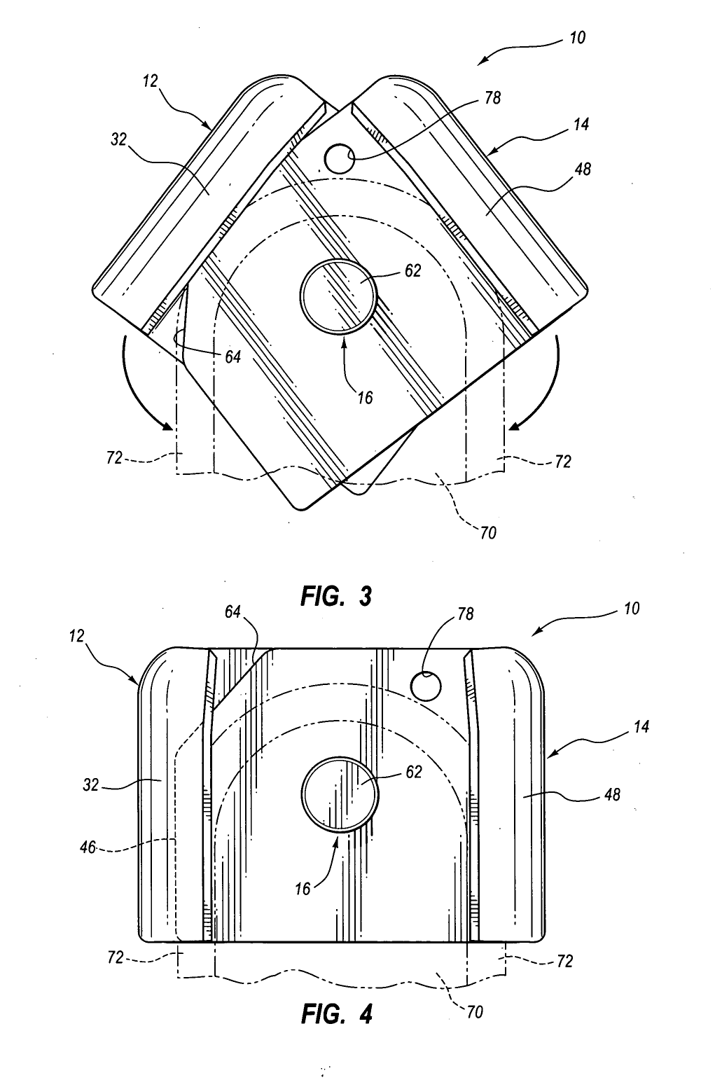

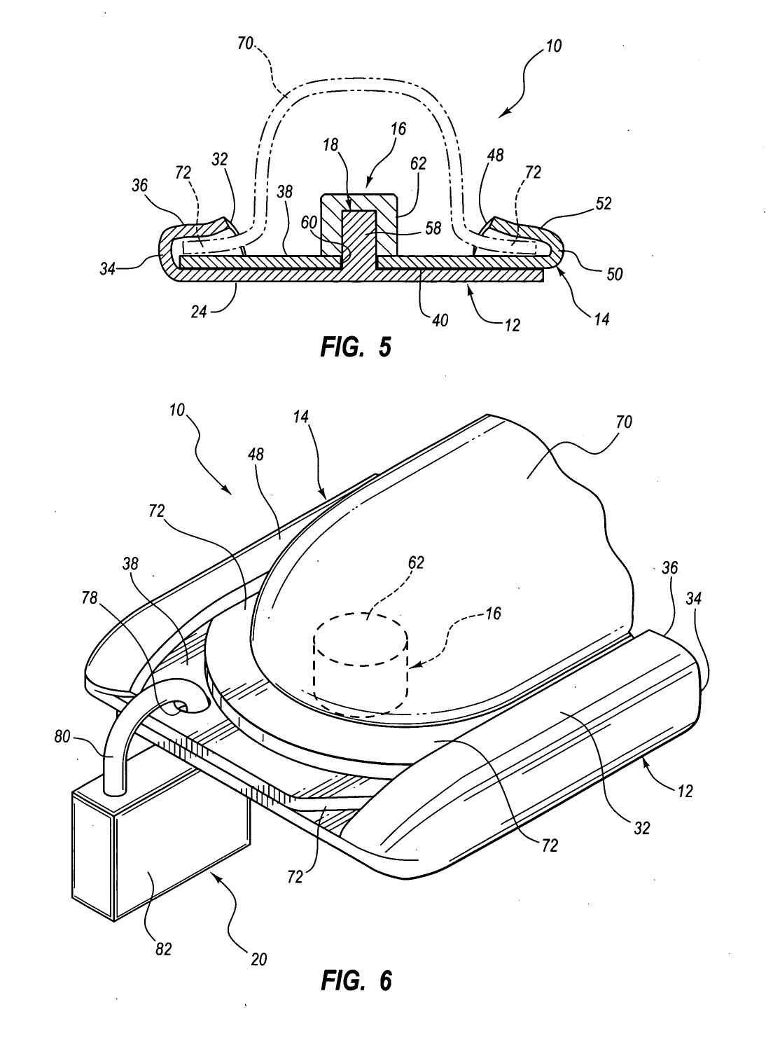

When using the hitch lock 10 to disable coupler 70 so that the coupler cannot be fitted over a ball attached to an unauthorized tow vehicle, the top plate 14 is fully pivoted with respect to the bottom plate 12, i.e., to the position of FIG. 3. The bumper 52 is positioned to extend into the ball receiving area of coupler 70 and the lock 10 is pushed onto the coupler, with the flange 72 extending into the spaces between the top plate and the bottoms of the in-turned legs 36 and 52. Both the bottom and top plates are rotated at the same time the lock system is pushed onto the coupler 70. When the bottom and top plates are rotated to position the side flanges 32 and 48 parallel to one another, i.e., to the position of FIGS. 4 and 5, a hole 76 through a corner of bottom plate 12 aligns with a hole 78 through a corner of top plate 14.

A hasp 80 of a padlock 82 is inserted through the aligned holes 76 and 78 and the padlock is locked in place. The hitch lock 10 cannot drop away from coupler 70 because the in-turned legs 36 and 52 rest on the flange 72. The hitch lock cannot be pulled off the end of the coupler 70 because the bumper 62 will engage the inner wall of the coupler to prevent such removal. Consequently, the hitch lock remains on the coupler 70 to prevent hook up of the coupler to the ball of an unauthorized tow vehicle.

Removal of the hitch lock 10 by unlocking and removing the padlock and sliding of the bottom and top plates 12 and 14 forward and off the coupler flange 72 readies the coupler for attachment to a tow vehicle.

Although a preferred embodiment of my invention has been herein described, it is to be understood that the present disclosure is by way of example and that variations are possible without departing from the subject matter coming within the scope of the following claims, which subject matter I regard as my invention.

I claim:

1. A trailer hitch lock comprising
a bottom plate having a flat surface, a front edge, a rear edge spaced from said front edge, a side edge at one side of said bottom plate, a side flange extending along an opposite side of said bottom plate and spaced from said side edge, said side flange including a first leg extending upwardly from said flat top surface and an in-turned second leg extending from said first leg a spaced distance from a portion of said top surface of said bottom plate;
a top plate having a flat bottom surface overlying said flat top surface of said bottom plate, a front edge, a rear edge, a side edge at one side of said top plate, a side flange extending along an opposite side of said top plate, said side flange including a first leg extending upwardly from a top surface of said top plate and an in-turned second leg extending from said first leg a spaced distance from said top surface of said top plate, whereby the distances from the top surface of said top plate to under surfaces of the in-turned legs are the same;
a pivot shaft fixed to and extending upwardly from a central area of said top surface of a top plate bottom plate, and a hole through a central area of said top plate, said pivot shaft extending through said hole and said hole being large enough to allow said top plate to rotate on said bottom plate and about said pivot pin, between a first position wherein said flanges are substantially normal to one another and a second position wherein said flanges are parallel to one another;
a bumper fixed to an upper end of said pivot pin and extending above said pivot pin and a portion of said top plate surrounding said hole through said top plate; and
means for locking said bottom plate and said top plate together when said flanges are in said second position parallel to one another.

2. A trailer hitch lock as in claim 1, wherein
the distance between the in-turned leg of each flange and the top surface of the top plate is just sufficient to allow a flange surrounding a coupler on an end of a trailer tongue to slide between said in-turned legs and said top surface of said top plate.

3. A trailer hitch lock as in claim 2, wherein
a corner of the top plate interconnecting the rear edge and the side edge is curved to allow said side edge to rotate beneath the in-turned leg of the flange of the bottom plate.

4. A trailer hitch lock as in claim 2, wherein
the means for locking the bottom and top plates together comprises a lock hole through each of said plates, said lock holes being aligned when said flanges are in the second position parallel to one another; and
a padlock having a hasp passing through said aligned lock holes.

5. A trailer hitch lock as in claim 3, wherein
the means for locking the bottom and top plates together comprises a lock hole through each of said plates, said lock holes being aligned when said flanges are in the second position parallel to one another; and
a padlock having a hasp passing through said aligned lock holes.
